(19) United States
(12) Patent Application Publication
(10) Pub. No.: US 2011/0269032 A1
(43) Pub. Date: Nov. 3, 2011

(54) COMBUSTOR FOR A FUEL CELL SYSTEM

(75) Inventors: Bernhard A. Fischer, Honeoye Falls, NY (US); Duane E. Jones, Rochester, NY (US)

(73) Assignee: DELPHI TECHNOLOGIES, INC., TROY, MI (US)

(21) Appl. No.: 12/964,806

(22) Filed: Dec. 10, 2010

(51) Int. Cl. H01M 8/06; B05B 1/24

(52) U.S. Cl. 429/408; 392/394

(57) ABSTRACT

A combustor generates and supplies hot combustion gases to a fuel reformer. The combustor includes a housing defining a combustion chamber. The combustor also includes a fuel vaporizer having a fuel tube with an electric heating element. The fuel tube is positioned such that a portion thereof extends into the combustion chamber and is exposed to the hot combustion gases exiting the combustion chamber. An electric current is supplied to the electric heating element to vaporize the liquid fuel within the fuel tube when the temperature within the combustion chamber is below is a predetermined temperature. Substantially no electric current is supplied to the electric heating element when the temperature within the combustion chamber is at least the predetermined temperature and the hot combustion gases passing over the portion of the fuel tube extending into the combustion chamber vaporize the liquid fuel within the fuel tube.

### STATEMENT REGARDING FEDERALLY SPONSORED RESEARCH OR DEVELOPMENT

This invention was made with Government support under DE-EE0000478 awarded by DOE. The Government has certain rights in this invention.

### TECHNICAL FIELD OF INVENTION

The present invention relates to a combustor with a combustion chamber for generating and supplying hot combustion gases to fuel cell system; more particularly to a combustor having a fuel vaporizer for vaporizing a liquid fuel combusted within a combustion chamber of the combustor; and even more particularly to a combustor with an electric heating element to vaporize a liquid fuel within the fuel vaporizer when the temperature within a combustion chamber of the combustor is below a predetermined temperature and a fuel tube extending into the combustion chamber for transferring heat from the hot combustion gases to the liquid fuel to vaporize the liquid fuel within the fuel tube when the temperature within the combustion chamber is at least the predetermined temperature.

### BACKGROUND OF INVENTION

Fuel cells which generate electric current by controllably combining elemental hydrogen and oxygen are well known. One form of fuel cell, known as a solid oxide fuel cell (SOFC), includes a plurality of cells known as a fuel cell stack. Each cell includes an anode layer and a cathode layer separated by a permeable electrolyte formed of a ceramic solid oxide. In order to generate an electric current, the fuel cell stack requires a temperature above about 600° C. and preferably 800° C. or even higher. Hydrogen for use in the SOFC is typically derived by catalytically reforming hydrocarbons in a fuel reformer. In order for catalytic reforming of hydrocarbons, the fuel reformer requires a temperature above about 500° C. and preferably 850° C. A known problem in the art is how to raise the temperature of the fuel reformer and the fuel cell stack at start-up to the threshold temperatures for each to operate.

In order to raise the temperature of the fuel reformer and fuel cell stack at start-up, it is known to provide a combustor for combusting hydrocarbons. The combustion of hydrocarbons produces hot combustion gases which are used to raise the temperature of the fuel reformer and fuel cell stack. A fuel vaporizer may be used to generate a vapor from a liquid hydrocarbon fuel to facilitate combustion of the hydrocarbons. It is known to provide a fuel vaporizer with an electric heating element which uses an electric current to vaporize the liquid hydrocarbon fuel passing through the fuel vaporizer. The vaporized hydrocarbon exiting the fuel vaporizer is then combusted in a combustion chamber of the combustor. The resulting hot combustion gases are then used to raise the temperature of the fuel reformer and fuel cell stack. However, start-up of the fuel reformer and fuel cell may have a duration of several hours. Accordingly, the electric current supplied to the electric heating element of the fuel vaporizer needs to be provided by an external source, for example, a battery with sufficient capacity to operate for the duration of the start-up.

What is needed is a combustor with a fuel vaporizer that reduces the electricity requirements to vaporize a liquid fuel for the duration of start-up of the fuel reformer and fuel cell.

### SUMMARY OF THE INVENTION

Briefly described, a combustor is provided for generating and supplying hot combustion gases to a fuel reformer. The combustor includes a housing defining a combustion chamber and having an exhaust port for discharging said hot combustion gases therefrom. The combustor also includes a fuel vaporizer having a fuel tube with an inlet for introducing liquid fuel therein and an outlet for dispensing vaporized fuel into the combustion chamber. The fuel vaporizer also includes an electric heating element disposed between the inlet and the outlet. The fuel tube is positioned such that a portion thereof extends into the combustion chamber and is exposed to the hot combustion gases before they exit the combustion chamber. An electric current can be supplied to the electric heating element to vaporize the liquid fuel within the fuel tube when the temperature within the combustion chamber is below is a predetermined temperature. Substantially no electric current nee be required to be supplied to the electric heating element when the temperature within the combustion chamber has attained at least the predetermined temperature and the hot combustion gases passing over the portion of the fuel tube extending into the combustion chamber are sufficient to vaporize the liquid fuel within the fuel tube.

### BRIEF DESCRIPTION OF DRAWINGS

This invention will be further described with reference to the accompanying drawings in which:

FIG. 1 is a schematic of a prior art fuel cell, fuel reformer, and combustor with fuel vaporizer; and

FIG. 2 is a schematic of a fuel cell, fuel reformer, and combustor with fuel vaporizer in accordance with the present invention.

### DETAILED DESCRIPTION OF INVENTION

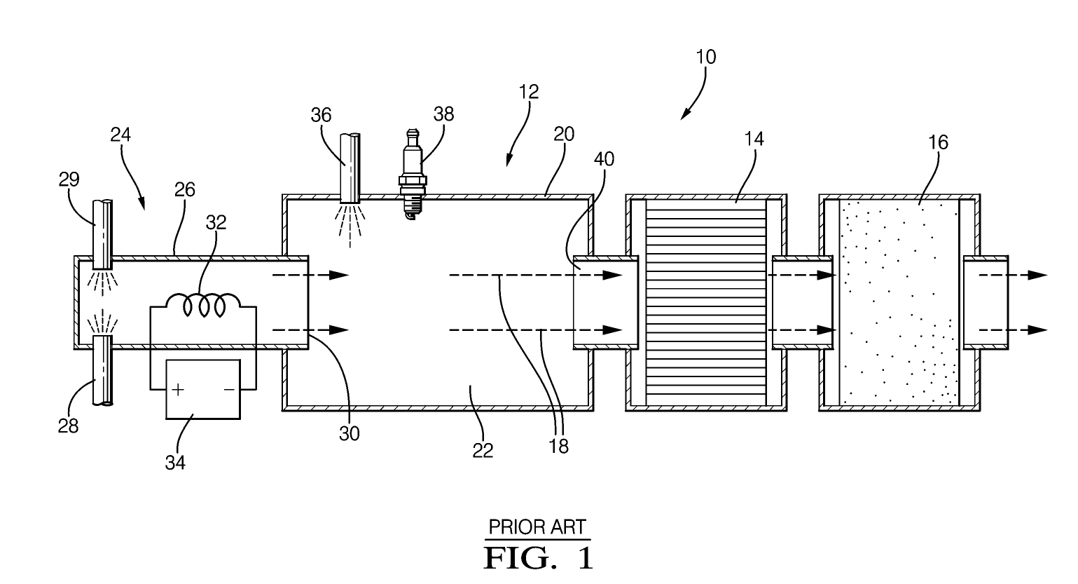

Referring to FIG. 1, prior art fuel cell system 10 is shown. Fuel cell system 10 includes combustor 12, fuel reformer 14, and fuel cell 16. Combustor 12 is fluidly coupled to fuel reformer 14 and supplies hot combustion gases indicated by arrows 18 to fuel reformer 14 when fuel cell system 10 is being started up. Fuel reformer 14 is fluidly coupled to fuel cell 16 and supplies reformate produced therein for use in fuel cell 16 to generate electricity in known fashion.

Combustor 12 includes housing 20 which defines combustion chamber 22 therewithin. Combustor 12 also includes fuel vaporizer 24 with fuel tube 26 having fuel inlet 28 for introducing a liquid hydrocarbon fuel therewithin and outlet 30 for dispensing vaporized fuel therefrom. Fuel tube 26 may also have fuel tube air inlet 29 for adding air to fuel tube 26 to be used as a carrier gas or for cleaning carbon deposits therefrom. Electric heating element 32 is disposed between fuel inlet 28 and outlet 30 and receives an electric current from an electric current source, illustrated in FIG. 1 as battery 34, for vaporizing the liquid hydrocarbon fuel within fuel tube 26. In this way, the liquid fuel entering fuel tube 26 from inlet 28 is vaporized by electric heating element 32 and the vaporized fuel is dispensed from outlet 30 to combustion chamber 22. It should be understood that electric heating element 32 may be disposed within fuel tube 26 or applied to the external surface of fuel tube 26.

Air may be mixed with the vaporized fuel in combustion chamber 22 by adding air through combustion chamber air inlet 36. The mixture of vaporized fuel and air is then combusted. Combustion of the vaporized fuel and air mixture may be aided by igniter 38 which extends into combustion chamber 22. Combustion of the vaporized fuel and air mixture produces hot combustion gases which exit combustion chamber 22 through exhaust port 40 to heat fuel reformer 14 and fuel cell 16 which are located downstream of combustor 12. Hot combustion gases that exit combustion chamber 22 flow in a path substantially distant from fuel tube 26 which extends into combustion chamber 22 only a short distance, for example, only about 10 mm or less. Accordingly, the hot combustion gases do little to provide heat to fuel tube 26. While some heat from the hot combustion gases may be radiated to fuel tube 26, the radiated heat is not sufficient to vaporize liquid fuel within fuel tube 26 without the continued supply of electric current to electric heating element 32.

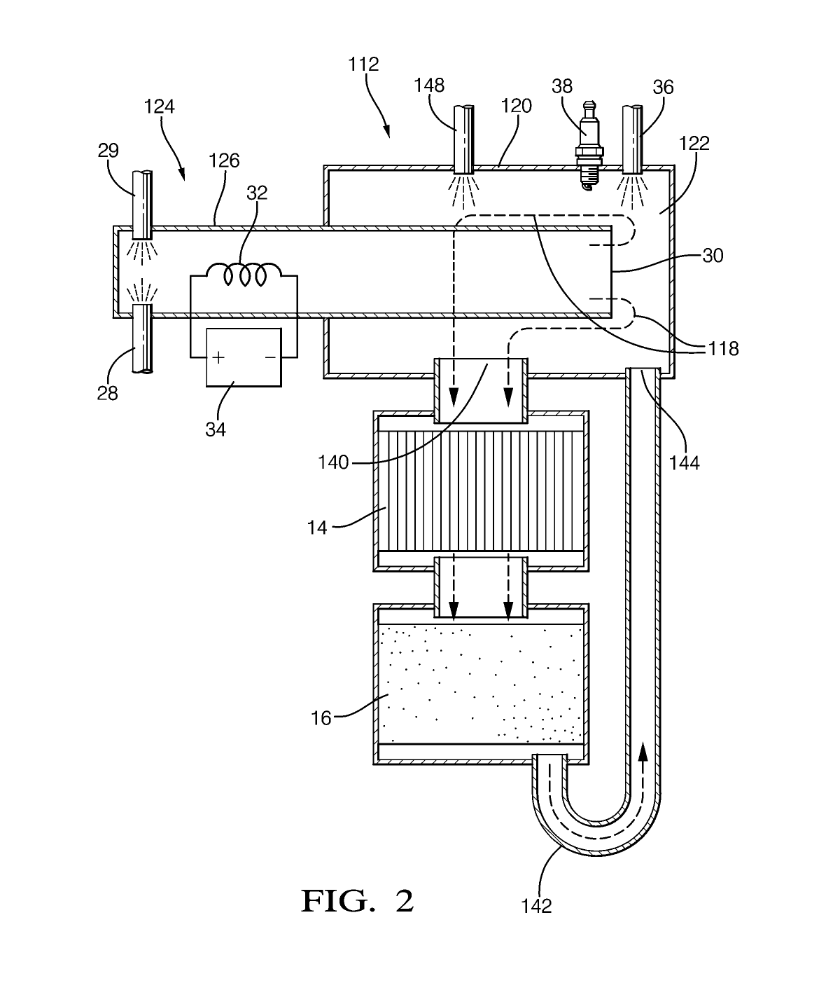

Now referring to FIG. 2, fuel cell system 110 in accordance with the present invention is shown. Elements of fuel cell system 110 that are substantially the same as elements of fuel cell system 10 will use the same reference numbers while elements of fuel cell system 110 that are not substantially the same as elements of fuel cells system 10 will use 100-series numbers.

Just as in fuel cell system 10, fuel cell system 110 includes fuel reformer 14 and fuel cell 16. Fuel cell system 110 also includes combustor 112 which is fluidly coupled to fuel reformer 14 and supplies hot combustion gases indicated by arrows 118 to fuel reformer 14 when fuel cell system 110 is being started up. Fuel reformer 14 is fluidly coupled to fuel cell 16 and supplies reformate produced therein for use in fuel cell 16 to generate electricity in known fashion.

Combustor 112 includes housing 120 which defines combustion chamber 122 therewithin. Combustor 112 also includes fuel vaporizer 124 with fuel tube 126 having fuel inlet 28 for introducing a liquid hydrocarbon fuel therewithin and outlet 30 for dispensing vaporized fuel therefrom. Fuel tube 126 may also have fuel tube air inlet 29 for adding air to fuel tube 26 to be used as a carrier gas or for cleaning carbon deposits therefrom. Electric heating element 32 is disposed between fuel inlet 28 and outlet 30 and receives an electric current from an electric current source, illustrated in FIG. 2 as battery 34, for vaporizing the liquid hydrocarbon fuel within fuel tube 126. In this way, the liquid fuel entering fuel tube 126 from fuel inlet 28 is vaporized by electric heating element 32 and the vaporized fuel is dispensed from outlet 30 to combustion chamber 122. It should be understood that electric heating element 32 may be disposed within fuel tube 126 or applied to the external surface of fuel tube 126.

Air may be mixed with the vaporized fuel in combustion chamber 122 by adding air through combustion chamber air inlet 36. The mixture of vaporized fuel and air is then combusted. Combustion of the vaporized fuel and air mixture may be aided by igniter 38 which extends into combustion chamber 122. Combustion of the vaporized fuel and air mixture produces the hot combustion gases which exit combustion chamber 122 through exhaust port 140 to heat fuel reformer 14 and fuel cell 16 which are located downstream of combustor 112. Exhaust port 140 and is arranged in relation to fuel tube 126 such that the hot exhaust gases exiting combustion chamber 122 pass over fuel tube 126 before exiting through exhaust port 140. Additionally, fuel tube 126 extends into combustion chamber 122 a significant distance, for example, from about 25 mm to about 250 mm or even more, thereby exposing a significant external surface area of fuel tube 126 to the flow of hot combustion gases. The exact length that fuel tube 126 extends into combustion chamber 122 for a particular design may be determined from several factors which may include, but are not limited to the type of fuel used, the amount of fuel required, and the temperatures achievable within combustion chamber 122. Additionally, fuel tube 126 may include heat transfer fins (not shown) or other features that increase heat transfer from combustion chamber 122 to the liquid fuel within fuel tube 126. In this way, a significant amount of heat is transferred from the hot combustion gases to fuel tube 126 and fuel within fuel tube 126. Accordingly, after combustion has begun and the temperature within combustion chamber 122 has reached a predetermined temperature, the supply of electric current to electric heating element 32 may be substantially discontinued because the heat transferred from the hot combustion gases to fuel tube 126 is sufficient to vaporize the liquid fuel within 126 fuel tube. Preferably, no electric current is supplied to electric heating element 32 when the temperature within the combustion chamber 122 has reached the predetermined temperature and the flow of hot combustion gases is sufficient to achieve vaporization within fuel tube 126.

In addition to combusting the fuel vaporized by fuel vaporizer 124, waste gas from fuel cell 16, for example anode tail gas, may be mixed with the vaporized fuel. The waste gas from fuel cell 16 may be communicated to combustion chamber 122 through waste gas conduit 142 and introduced into combustion chamber 122 through waste gas inlet 144. The waste gas is mixed with the vaporized fuel and air and combusted in the same way the mixture of only fuel and air is combusted. In this way, energy may be liberated from the waste gas of fuel cell 16 that may otherwise go unused.

The hot combustion gases that are produced may be at a temperature that is higher than desired to be supplied to fuel reformer 14. In order to lower the temperature of the hot combustion gases to an acceptable level before being supplied to fuel reformer 14, air may be added to the hot combustion gases through cooling air inlet 146. Cooling air inlet 146 is positioned within combustion chamber 22 a sufficient distance from exhaust port 140 such that the air is mixed only with the hot combustion gases rather than the constituents that are yet to be combusted. In this way, the hot combustion gases that are supplied to fuel reformer 14 may be controlled to a temperature that is desired for operation of fuel reformer 14.

While fuel cell 16 has been described as a solid oxide fuel cell, it should now be understood that other types of fuel cells known in the art may also be used.

While fuel cell system 110 is represented in FIG. 2 as separate individual elements, it should be understood that combustor 112, fuel reformer 14, and fuel cell 16 may be formed as an integrated unit.

While this invention has been described in terms of preferred embodiments thereof, it is not intended to be so limited, but rather only to the extent set forth in the claims that follow.

We claim:

1. A combustor for generating and supplying hot combustion gases to a fuel reformer, said combustor comprising:
a housing defining a combustion chamber and having an exhaust port for discharging said hot combustion gases therefrom; and
a fuel vaporizer having a fuel tube with an inlet for introducing liquid fuel therewithin, an outlet for dispensing vaporized fuel therefrom to said combustion chamber, and an electric heating element disposed between said inlet and said outlet, wherein a portion of said fuel tube extends into said combustion chamber and is exposed to said hot combustion gases exiting said combustion chamber;
wherein an electric current can be supplied to said electric heating element to vaporize said liquid fuel within said fuel tube when the temperature within said combustion chamber is below a predetermined temperature, and wherein substantially no electric current need be supplied to said electric heating element when the temperature within said combustion chamber is at least said predetermined temperature and said hot combustion gases passing over said portion of said fuel tube are sufficient to supply enough heat to vaporize said liquid fuel within said fuel tube.

2. A combustor as in claim 1 wherein said combustion chamber includes a first air inlet for mixing air with said vaporized fuel within said combustion chamber.

3. A combustor as in claim 1 wherein said combustion chamber includes a waste gas inlet for mixing waste gas from a fuel cell with said vaporized fuel.

4. A combustor as in claim 1 wherein said combustion chamber includes a second air inlet for mixing air with said hot combustion gases within said combustion chamber.

5. A combustor as in claim 1 wherein said fuel vaporizer includes a third air inlet for supplying air within said fuel tube.

6. A combustor as in claim 1 wherein said portion of said fuel tube is between said outlet of said fuel tube and said exhaust port.

7. A fuel cell system comprising:
a fuel reformer for generating reformate from a hydrocarbon fuel;
a fuel cell for generating an electric current, said fuel cell being fluidly coupled to said fuel reformer and receiving said reformate for use in generating said electric current; and
a combustor for generating and supplying hot combustion gases to said fuel reformer, said combustor comprising:
a housing defining a combustion chamber and having an exhaust port for discharging said hot combustion gases therefrom; and
a fuel vaporizer having a fuel tube with an inlet for introducing liquid fuel therewithin, an outlet for dispensing vaporized fuel therefrom to said combustion chamber, and an electric heating element disposed between said inlet and said outlet, wherein a portion of said fuel tube extends into said combustion chamber and is exposed to said hot combustion gases exiting said combustion chamber;
wherein an electric current can be supplied to said electric heating element to vaporize said liquid fuel within said fuel tube when the temperature within said combustion chamber is below a predetermined temperature, and wherein substantially no electric current need be supplied to said electric heating element when the temperature within said combustion chamber is at least said predetermined temperature and said hot combustion gases passing over said portion of said fuel tube are sufficient to supply enough heat to vaporize said liquid fuel within said fuel tube.

8. A fuel cell system as in claim 7 wherein said combustion chamber includes a first air inlet for mixing air with said vaporized fuel within said combustion chamber.

9. A fuel cell system as in claim 7 wherein said combustion chamber includes a waste gas inlet for mixing waste gas from a fuel cell with said vaporized fuel.

10. A fuel cell system as in claim 7 wherein said combustion chamber includes a second air inlet for mixing air with said hot combustion gases within said combustion chamber.

11. A fuel cell system as in claim 7 wherein said fuel vaporizer includes a third air inlet for supplying air within said fuel tube.

12. A fuel cell system as in claim 7 wherein said portion of said fuel tube is between said outlet of said fuel tube and said exhaust port.
